(19) United States
(12) Patent Application Publication
(10) Pub. No.: US 2006/0144195 A1
(43) Pub. Date: Jul. 6, 2006

(54) Hammer having a rotatable head

(76) Inventor: Robert Tanga, Atlanta, GA (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 11/253,532

(22) Filed: Oct. 19, 2005

Related U.S. Application Data
(60) Provisional application No. 60/620,531, filed on Oct. 20, 2004.

(51) Int. Cl. B25G 1/01; B25D 1/00

(52) U.S. Cl. 81/20; 81/489

(57) ABSTRACT

A tool having a head repositionably mounted to an end of an elongate handle. In exemplary embodiments, the handle has an angle of about 10° to about 30°. The hammer also includes a locking mechanism for securing the connection between the head and the handle once the desired position has been set.

### CROSS-REFERENCE AND PRIORITY CLAIM TO RELATED APPLICATIONS

To the fullest extent permitted by law, the present nonprovisional patent application claims priority to and the full benefit of provisional patent application entitled “Hammer Having a Rotatable Head”, filed on Oct. 20, 2004, having assigned Ser. No. 60/620,531.

### FIELD OF THE INVENTION

The present invention relates generally to the field of carpentry tools, and particularly to a hammer or ax having a rotatable head.

### BACKGROUND OF THE INVENTION

Many persons, including carpenters and handymen, use hammers, such as claw hammers, for both pounding nails and as a pry bar for removing nails. However, there are times when a standard hammer is inadequate. For example, when removing crown molding or baseboards, the handle of the hammer may hit or come into contact with the ceiling or floor, which may make the removal of such objects more difficult and more time-consuming. In such situations, the user can try to orient the hammer at an awkward angle or can try to use a different tool for the task.

Thus, it can be seen that needs exist for a hammer that allows persons to access areas in tight spaces or at tight angles.

### SUMMARY OF THE INVENTION

Briefly described, the present invention comprises a hammer with a radially rotatable head that can be rotated at an angle up to 360° about the handle. Near the proximal end of the handle of the hammer is an angle of about 10° to about 30°. The head of the hammer has a bore therein for receiving a shank portion of the handle. The hammer also includes a locking mechanism for securing the resulting connection between the head and the handle once the desired position has been set.

In another aspect, the present invention comprises a hammer having a head that can be radially rotated about the handle to a number of predefined positions. Preferably, the handle has a shank portion, which has a polygonal cross-section. The shape of the cross-section can define the number of positions to which the head can be set.

In yet another aspect, the present invention comprises a hammer having a plurality of bores therein for receiving a shank portion of the handle of the hammer. The location and orientation of the bores in the head define the angle of handle relative to the head.

In still another aspect, the present invention comprises a hammer having a head pivotally mounted to a handle such that head of the hammer can pivot about the handle in a forward or backward direction and then be locked into place.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

FIGS. 1-6 show a hammer having a rotatable head in accordance with an exemplary embodiment of the present invention.

FIGS. 7-10 show a hammer having a rotatable head in accordance with another exemplary embodiment of the present invention.

FIG. 11 shows a hammer having a rotatable head in accordance with yet another exemplary embodiment of the present invention.

FIG. 12 shows a hammer having a rotatable head in accordance with still yet another exemplary embodiment of the present invention.

FIG. 13 shows a hammer having a rotatable head in accordance with still yet another exemplary embodiment of the present invention.

FIG. 14 shows an ax having a rotatable head in accordance with another exemplary embodiment of the present invention.

FIG. 15 shows a hammer having a rotatable head in accordance with another exemplary embodiment of the present invention.

FIG. 16 shows a hammer having a rotatable head in accordance with another exemplary embodiment of the present invention.

### DETAILED DESCRIPTION OF EXAMPLE EMBODIMENTS

The present invention may be understood more readily by reference to the following detailed description of the invention taken in conjunction with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

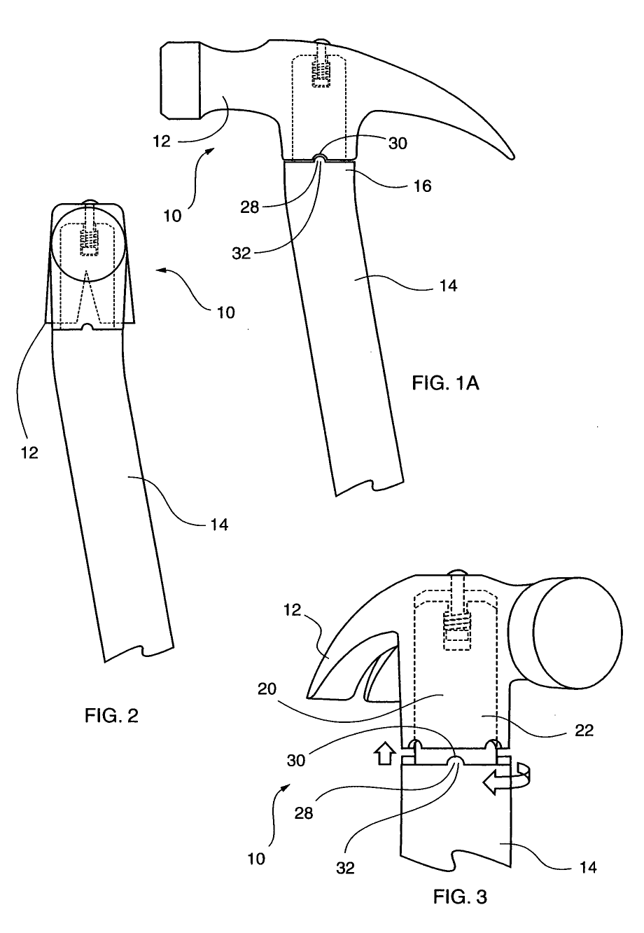

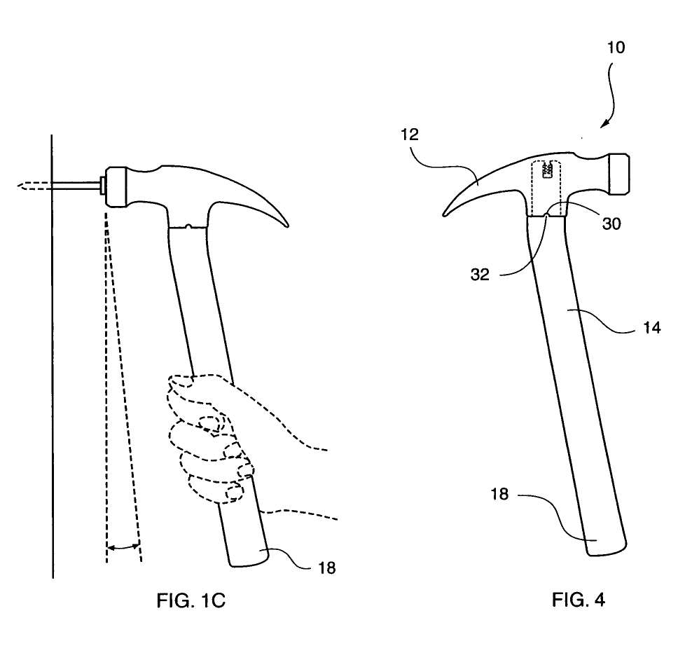

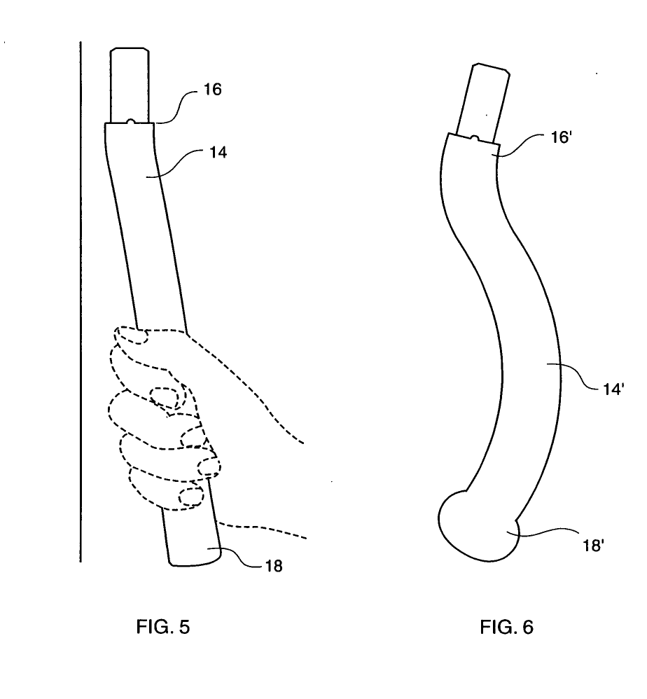

With reference now to FIGS. 1-5, a hammer 10 is shown having a head 12 radially rotatable about a handle 14 thereof. The shape of the head 12 can be the same or a similar shape to that of a standard claw hammer head as depicted in the figures, or can be the general shape of a ball peen hammer head, a mallet head, or other shaped hammer head. Moreover, it will be understood by those skilled in the art that the head 12 can be made in various shapes and sizes and made of various materials, including metals such as titanium and steel, or other durable materials.

The handle 14 has a proximal end 16 and a distal end 18. Preferably, the handle 14 is substantially cylindrical and mostly straight with an angle α near its proximal end 16 so as to, for example, compensate for the torque of the user's hand when the user swings the hammer 10 towards a target, which in turn allows the head 12 of the hammer to hit the target flat or the nail square on its head. The angle α also provides clearance for the user's hand when the hammer is used in a tight corner. Also preferably, the angle α is about 10° to about 30°, although the present invention includes larger and smaller angles at any point along the length of the handle 14. In an alternate embodiment, as depicted in FIG. 6, the handle 14′ can be a somewhat arcuate handle so as to provide a more comfortable grip for the user. In yet another embodiment, the handle can be bowed. Moreover, it will be understood by those skilled in the art that the handle 14 can be made in various shapes and sizes and made of various materials, including wood, fiberglass, or other durable materials.

The head 12 sits crosswise on the handle 14 at the handle's proximal end 16. The head 12 has bore 20 therein for receiving a shank portion 22 of the handle 14. In the first depicted embodiment, the shank portion 22 is generally cylindrical and is integral with the handle 14. Within the bore 20 are a retaining screw 24, or a roll pin, and a biasing element 26, such as a spring, which engage the end of the shank portion 22 and retain it within the head 12. Preferably, the head 12 of the hammer 10 remains at least partially attached to the handle 14 when rotating the head; however, the head can also be fully disengaged from the handle and then resecured to the handle. Also preferably, the hammer 10 includes a locking mechanism 28 for securing the connection between the head 12 and the handle 14. In the depicted embodiments, the head 12 comprises a recess 30 that cooperates with a nub 32 of the handle 14 to lock the head to the handle. Alternately, the nub 32 can be located in the head 12 and the recess 30 can be located in the handle 14. For example, there can be four nubs that align with four recesses to allow the head to be rotated in 90° increments up to 360°. It will be understood that more or fewer combinations of nubs and recesses can be employed to allow more or fewer positions to which the head can be set without deviating from the scope of the present invention.

Those skilled in the art will understand that other locking mechanisms can be employed as well. One example is depicted in FIG. 13. Additionally, a modified woodruff key arrangement can be used. A bolt with a washer can be inserted through the top of the head and into the bore for holding the shank in place relative to its longitudinal axis. The shank of the handle can have a woodruff slot and key therein that mates with one of a plurality of woodruff key slots formed in the head of the hammer. Thus, when the bolt is loosened, the user can then rotate the head to the desired location. Additionally, a detent ball arrangement can be used such that a detent ball located within the shank of the handle engages a socket. A spring acting on the shank biases an element having a shoulder portion towards the top of the hammer such that the shoulder portion holds the ball in the socket. When force is applied to overcome the bias of the spring, the ball releases from the socket, which in turn allows the user to rotate the head of the hammer to the next desired position having a socket such that the bias of spring causes the shoulder portion to push the ball into the socket.

In operation, the user applies force to the head 12 and pulls the head in a direction away from the handle 14. This causes the head 12 of the hammer 10 to partially disengage from the handle 14. The user then rotates the head 12 to the desired location and pushes the head into contact with the shank portion 22 such that the retaining screw 24 engages and secures the shank portion, while the nub 32 of the locking mechanism 28 aligns with the recess 30 to secure the head to the handle. The hammer 10 is now ready to be used for the desired task.

Notably, there is a tradeoff between having a tight clearance (fit) between the head and the shank and ease of rotating the head. A larger clearance (looser fit) between the head and the shank permits the user to more easily rotate the head without the use of additional tools. However, a larger clearance provides for a less stable hammer, as the shank of the hammer may tend to wobble within the head when the hammer is used for pounding. On the other hand, a tight clearance provides for a more stable hammer, but may make it more difficult to change the rotational position and may require additional tools to rotate the head of the hammer about the handle.

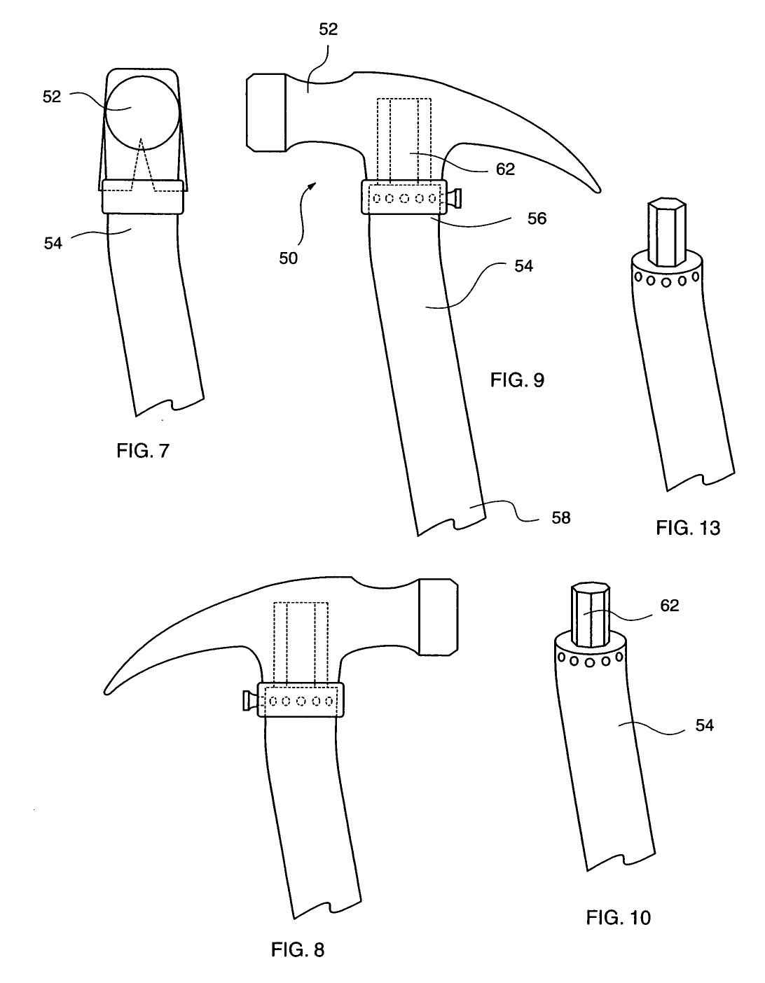

An alternate embodiment of the hammer is depicted in FIGS. 7-10. The hammer 50 is substantially similar to the hammer 10 but with the exceptions noted herein. The hammer 50 has a head 52 and a handle 54 having a proximal end 56 and a distal end 58. A shank portion 62, which has a polygonal cross-section as compared to the circular cross-section of the first embodiment, extends from the handle's proximal end 56. In the depicted embodiments, the cross-section is shown as a hexagon, which allows the head to be rotated in 60° increments, or an octagon, which allows the head to be rotated in 45° increments. Thus, in embodiments where the shank portion 62 has an octagonal cross-section, the head 52 of the hammer 50 can be locked into place in 1 of 8 radial positions. And in embodiments where the shank portion 62 has a hexagonal cross-section, the head 52 of the hammer 50 can be locked into place in 1 of 6 radial positions. Thus, the shape of the cross-section defines the number of positions to which the head 52 can be set. Those skilled in the art will understand that the shank portion 62 can be made other shapes, including triangular, square, pentagonal, etc. so as to provide fewer or additional positions to which the head can be set.

The hammer 50 also preferably includes a locking mechanism 58 to secure the connection between the head and the handle. For example, a twist lock or a threaded connection can be employed as depicted in FIG. 7. Alternately, a pin lock comprising a movable pin located head 52 can cooperate with a bore in the handle 54 to lock the head to the handle as depicted in FIG. 8. However, it should be understood that the movable pin can be located in the handle 54 and the bores drilled in the head 52. Preferably, the number of bores drilled in either the handle 14 or the head 12 coincides with the number of positions to which the head can be set. Also, those skilled in the art will understand that other mechanisms for securing the head to the handle, including the other locking mechanisms described herein, can be employed as well.

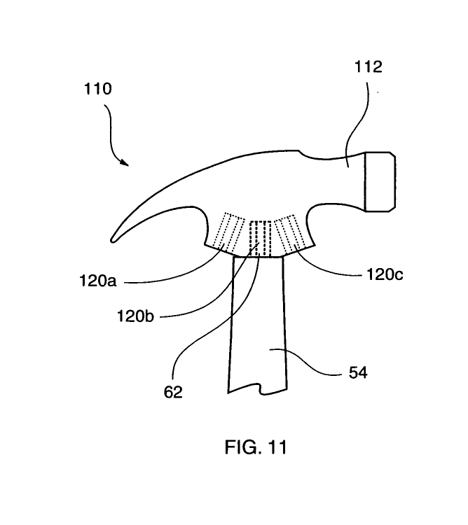

Another alternate embodiment of the hammer is depicted FIG. 11. The hammer 110 of FIG. 11 is substantially similar to the hammer 50 of FIGS. 7-10, with the exception that the head 112 has a plurality of bores 120 therein for receiving the shank portion 62 of the handle 54. The location and the orientation of the bores define the angle of the handle 54 relative to the head 152. In the depicted embodiment, three bores are shown, although any number of bores extending at any angle can be used to change the angle of the handle 54 relative to the head 112.

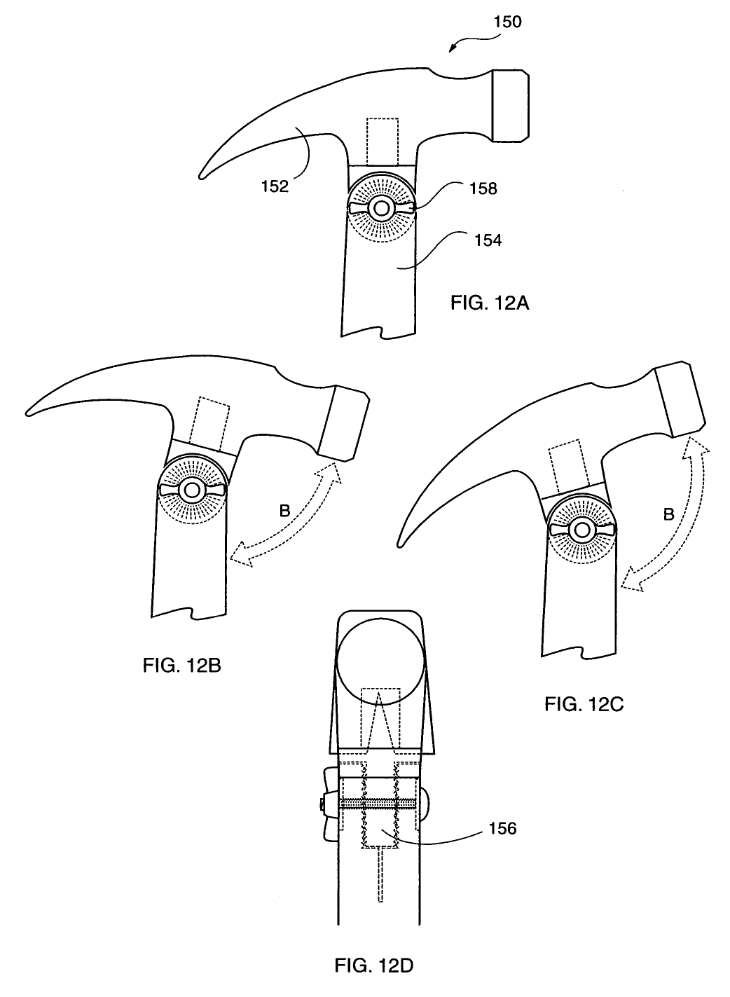

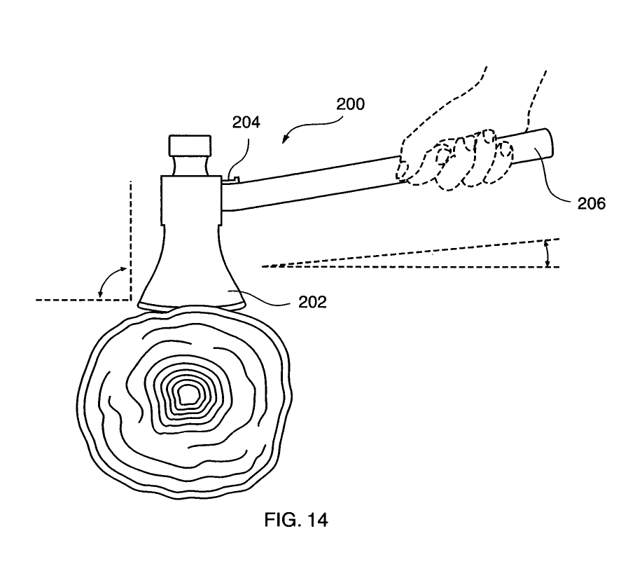

Yet another alternate embodiment of the hammer is depicted in FIG. 12. The hammer 150 has a head 152 and a handle 154 pivotally connected to head. The pivotal connection can be accomplished with a ratchet wheel 156 that can be tightened and locked into place with a wing nut 158. Thus, the head 152 of the hammer 150 can pivot about the handle 154 in a forward or backward direction and then be locked into place to achieve the desired angle β. The user can adjust the angle β to, for example, compensate for the torque caused by his or her hand when the user swings the hammer 150 towards the target, which in turn allows the head 152 of the hammer to hit the target flat or the nail square on its head. The user can also adjust the angle β to a different angle so as to provide better leverage for using the hammer as a pry bar.

Notably, one of the many advantages of the present invention is that it allows a user to use a single handle with a plurality of different heads. For example, the user can quickly and easily interchange the various heads (including but not limited to a claw head, ax head, a ball peen head, and a mallet head) of the hammer. For exemplary purposes only, see FIG. 14 showing an additional alternate embodiment 200 having a removable and rotatable ax head 202, wherein a pullable locking pin 204 is utilized to secure the head into a desired position. Additionally, the handle 206 preferably has an angled portion to further facilitate a square strike of the target.

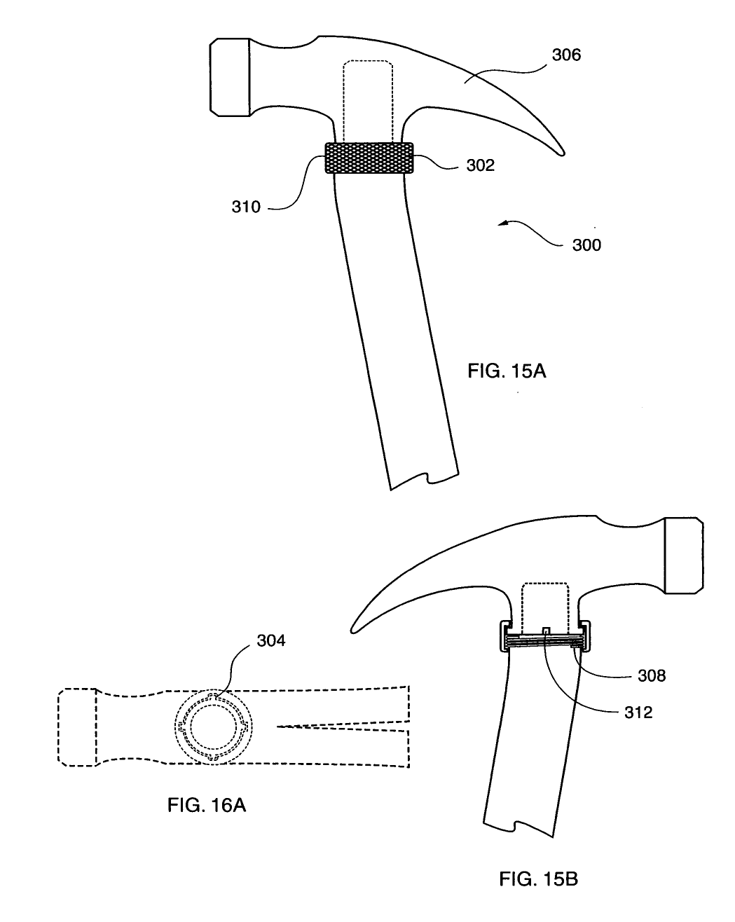

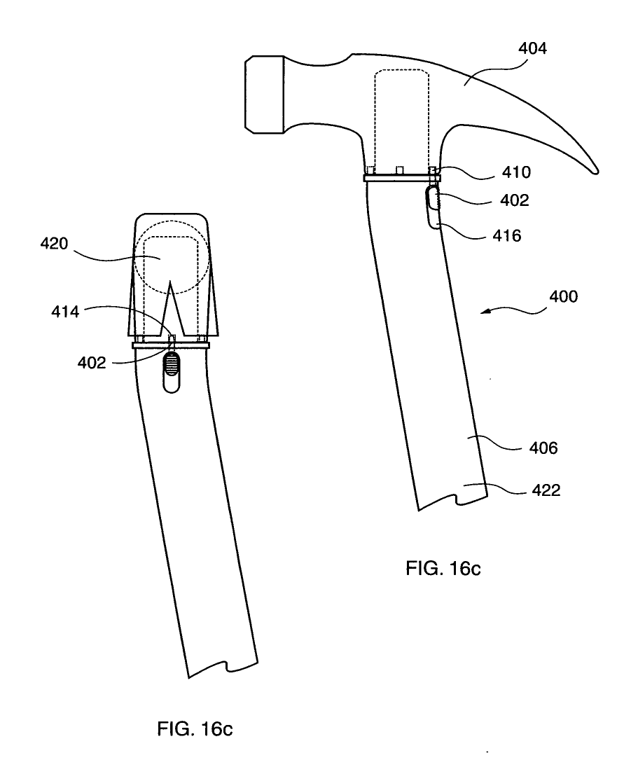

An additional alternate embodiment 300 is shown in FIG. 15, wherein the locking means is a pull-down sleeve mechanism 302 having a plurality of teeth 304 preferably in head 306, a sleeve 310 and a spring 308 for urging said sleeve 310 upwards toward head 306. More specifically, sleeve 310 is pulled down to disengage sleeve 310 from teeth 304, such that head 306 may be rotated to a desired position and subsequently, once head 306 is rotated sleeve 310 is released and is urged by spring 308 back into the engaged position within teeth 304. Additionally, head 306 may be rotated to preferably a 30 degree position, wherein notches 312 are aligned and head 306 is removable from handle 314 via a quick release channel (see also FIG. 16a).

An additional alternate embodiment 400 is shown in FIG. 16, wherein the locking means is a pull-down pin mechanism 402 having a plurality of apertures 408 preferably in head 404, pin 402 and a spring 420 for urging said pin 402 upwards toward head 406. Pin 402 preferably comprises distal end 410 and proximal end 416. More specifically, pin 402 is pulled down via proximal end 416 to disengage distal end 410 from aperture 408, such that head 404 may be rotated to a desired position and subsequently, once head 404 is rotated, pin 402 is released and is urged by spring 420 back into the engaged position within aperture 408. Additionally, head 404 may be rotated to preferably a 30 degree position, wherein notches 412 are aligned and head 404 is removable from handle 406 via a quick release channel 422 (see FIG. 16a).

While the invention has been described with reference to preferred and example embodiments, it will be understood by those skilled in the art that a variety of modifications, additions and deletions are within the scope of the invention, as defined by the following claims.

What is claimed is:

1. A hammer comprising:
a handle; and
a head rotatable about an end of the handle.

2. The hammer of claim 1, wherein the hammer further includes a claw hammer.

3. The hammer of claim 1, wherein the hammer further includes a ball peen hammer.

4. The hammer of claim 1, wherein the hammer further includes a mallet.

5. The hammer of claim 1, wherein the handle has an angle of about 10° to about 30°.

6. The hammer of claim 1, wherein the end of the handle has a circular cross-section.

7. The hammer of claim 1, wherein the end of the handle has a polygonal cross-section.

8. The hammer of claim 1, wherein the head has at least one bore for receiving the end of the handle.

9. The hammer of claim 1, wherein the hammer is an ax.

10. A hammer, comprising:
an elongate handle having first and second ends; and
a head repositionably mounted to the first end of the elongate handle.

11. The hammer of claim 9, further comprising a locking mechanism for securing the head to the elongate handle.

12. A hand tool, comprising:
an elongate handle having first and second ends;
a plurality of interchangeable heads, wherein each head can be repositionably mounted to the first end of the elongate handle; and
means for locking said head into a desired position.

13. The hand tool of claim 12, wherein the hand tool further includes a claw hammer.

14. The hand tool of claim 12, wherein the hand tool further includes a ball peen hammer.

15. The hand tool of claim 12, wherein the hand tool further includes a mallet.

16. The hand tool of claim 12, wherein the hand tool further includes an ax.
